(19) United States
(12) Patent Application Publication
(10) Pub. No.: US 2012/0254027 A1
(43) Pub. Date: Oct. 4, 2012

(54) Terminal Authenticity Verification

(76) Inventor: Lars Olof Kanngard, Bangkok (TH)

(21) Appl. No.: 13/341,560

(22) Filed: Dec. 30, 2011

Related U.S. Application Data
(63) Continuation of application No. 12/764,926, filed on Apr. 21, 2010.
(60) Provisional application No. 61/171,235, filed on Apr. 21, 2009.
(60) Provisional application No. 61/171,246, filed on Apr. 21, 2009.
(60) Provisional application No. 61/171,239, filed on Apr. 21, 2009.
(60) Provisional application No. 61/171,244, filed on Apr. 21, 2009.
(60) Provisional application No. 61/428,244, filed on Dec. 30, 2010.
(60) Provisional application No. 61/428,245, filed on Dec. 30, 2010.

(51) Int. Cl. G06Q 40/02

(52) U.S. Cl. 705/41

(57) ABSTRACT

Methods and systems for improving non-bank payment solutions through terminal authenticity verification. One group of improvements uses the secure payment capabilities of the above architecture to implement a bill payment system. Electronic payments from consumers who are not bank customers are now completely secure. A variety of methods are discussed to include non-banking consumers in this payment system. Another group of improvements uses the secure payment capabilities of the above architecture to implement a payroll system which allows non-banking or unbankable employees (or contractors or vendors) to receive electronic payment, and to easily reroute portions of their payments electronically to various destinations. The secure transaction capabilities of the above architecture make this possible.

### CROSS-REFERENCE

Priority is claimed from U.S. provisional applications 61/428,245 and 61/428,244, both of which are hereby incorporated by reference.

Priority is also claimed (where available) from US2011-0066512, and therethrough to 61/171,235, 61/171,246, 61/171,239, and 61/171,244, all of which are hereby incorporated by reference.

### BACKGROUND

The present application relates to payment systems, and more particularly to a method of verification of terminal authenticity.

Note that the points discussed below may reflect the hindsight gained from the disclosed inventions, and are not necessarily admitted to be prior art.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 schematically shows one method by which verification of terminal authenticity might occur.

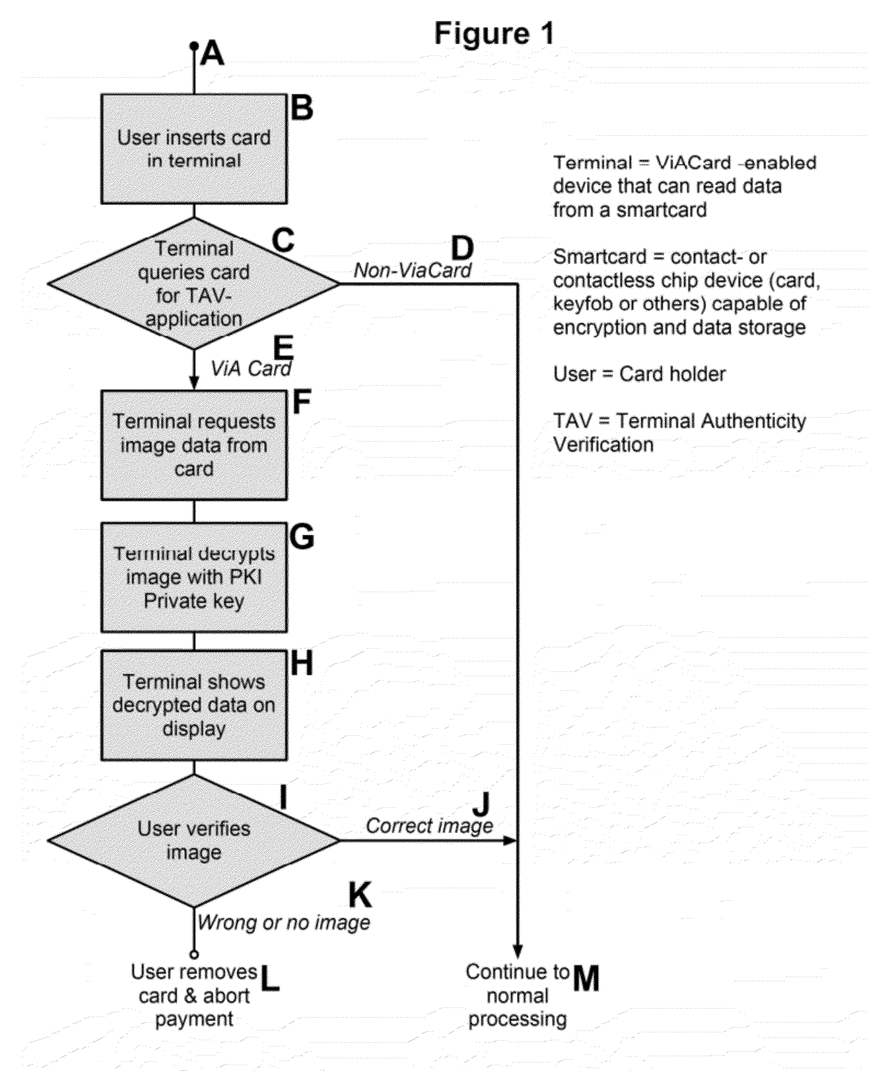

FIG. 2 shows an example of a transaction made using one sample embodiment of a disclosed payment system.

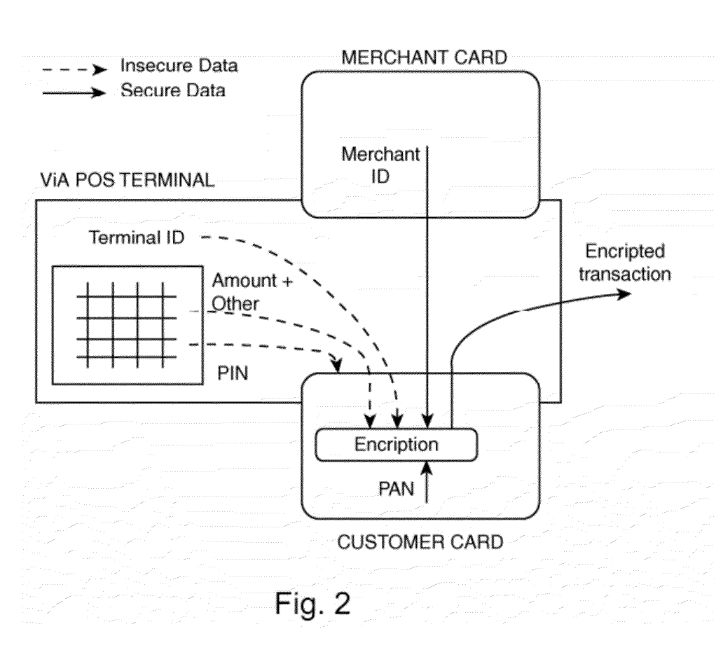

FIG. 3 shows one sample embodiment of an off-line credit implementation.

FIG. 4 shows an example of a simplified printout produced by a terminal.

FIG. 5 schematically shows one sample embodiment of terminal interaction from the view of a buyer.

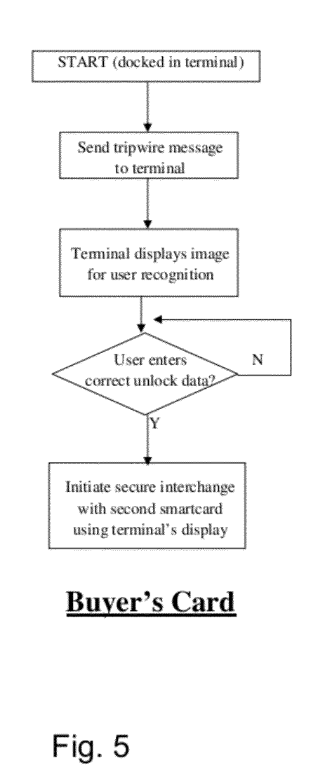

FIG. 6 schematically shows one sample embodiment of terminal interaction from the view of a merchant.

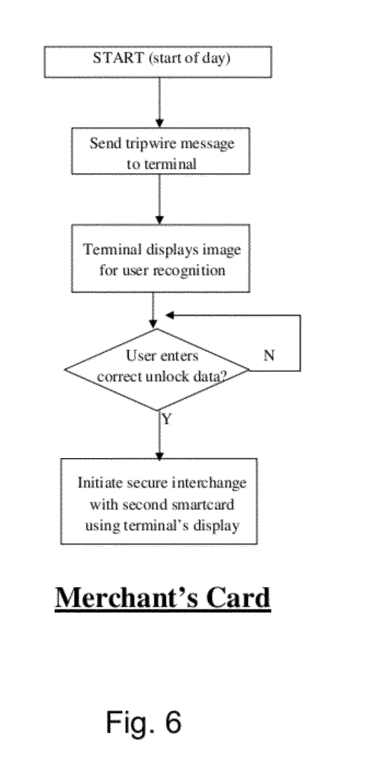

FIG. 7 schematically shows one sample embodiment of interaction with a terminal for the purpose of bill management and payment.

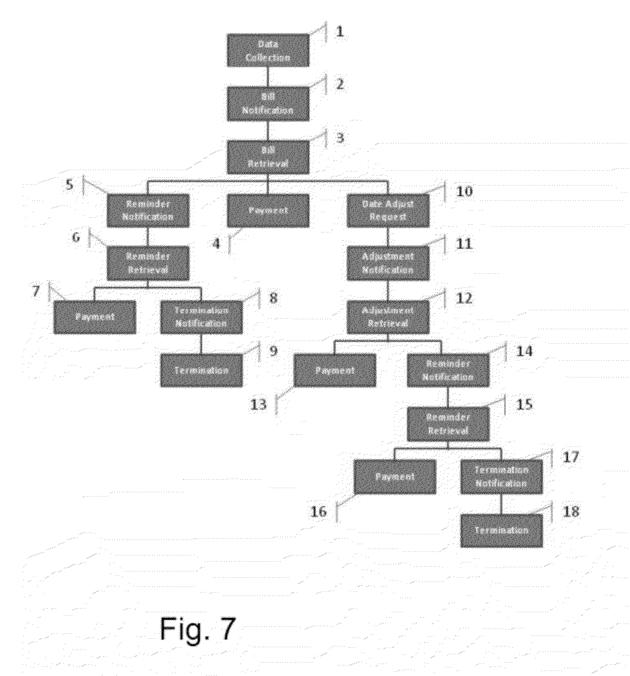

FIG. 8 schematically shows one sample embodiment of data collection for bill management.

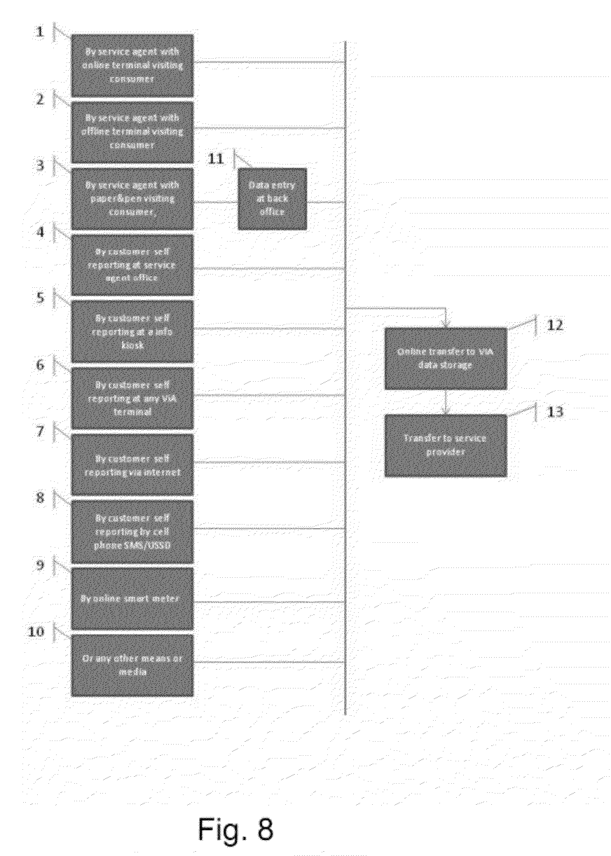

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

This application discloses improvements and modifications and alternatives to the basic secure card transaction (SCT) architecture disclosed in for example US 2011-0066512 A1.

Secure Card Transaction Systems and Architectures

This document describes the SCT architecture which provides a more secure transaction on a point of sale (POS) device.

The rationale behind this architecture is the assumption that the POS terminal is compromised, but we still want to be able to make a transaction as secure as possible.

This is in contrast to the current PCI-DSS and EMV standards where a lot of work is put into making the POS terminal very secure thus increasing the complexity and design of the POS itself.

By assuming that the terminal and other links in the chain towards the processing center are compromised either on a hardware- or software-level we quickly realized that we need to move as much cardholder data, request building and encryption as possible out of the terminal and into to the card itself.

By doing this a compromised terminal cannot do much harm on a large scale, and a compromised card could only affect one single cardholder.

In the case of the SCT method described in this document we are not trying to retrofit a legacy network with a secure method. We are creating something new that fits into our business model. We will not have a chain of parties involved in the transaction, no external gateways that need to route the transactions, no processing outside our own network. It will all be handled by us.

Information Flow during a Transaction

The normal flow of information is typically somewhat like the following:
The transaction type and amount is entered by the merchant
The customer smartcard is inserted
The customer smartcard is opened by the pin code
The terminal helps the merchant- and the customer smartcards to negotiate a session encryption key
The terminal retrieves the encrypted merchant id from the merchant smartcard.
The terminal sends the amount and a opaque block of information consisting of among other things the terminal id, the encrypted merchant id, and the transaction code to the customer smartcard.
The customer smartcard retrieves the personal account number (PAN) from itself
The customer smartcard encrypts all of this using its private RSA key into a message and delivers it to the terminal. The message needs to have an unencrypted header with a card reference number so the datacenter can decrypt it using the public RSA key belonging to the card.
The terminal send the message as-is to the datacenter for processing.

There are some additional functions that can also be implemented on the cards:

Customer Card—PIN Replacement

This function is rather self-explanatory. It allows the user to change the PIN on the card.

Customer Card—Adjust Off-Line Credit Value

This is preferably implemented as a suite of functions to handle the updates of the off-line credit.

The off-line credit is used to allow for some low value purchases to be accepted even if the terminal is temporarily off-line with the processing center.

The terminal will accept the transaction and store the encrypted transaction in the blob storage area of the merchant smartcard. All of these pending transactions are sent for processing at when the terminal is on-line again.

Whenever an off line transaction is taking place the off-line credit value on the customer card should be reduced so it's not possible to make an infinite number of off-line transactions.

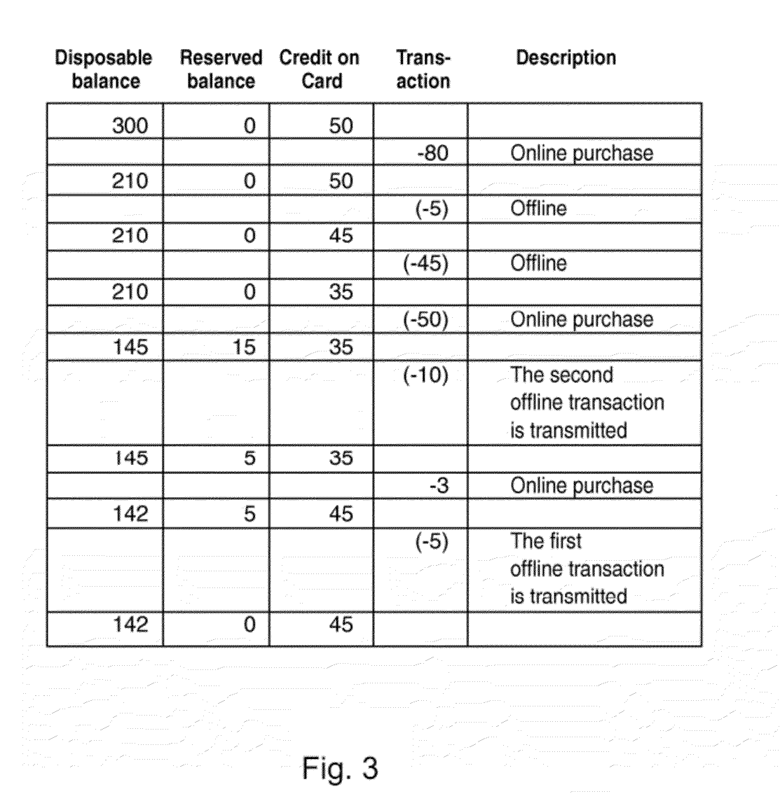

FIG. 3 is a table illustrating some important concepts.

When the card is used the next time in a normal on-line situation the credit value will be adjusted with the off-line amount(s) that has been received by the processing center during the period.

Please note that this is not the same thing as a wallet on the card. A wallet usually means that funds must be transferred in advance from the customer account thus reducing the balance of the account. A wallet is also meant to be used in a non-error situation, this in contrast to this credit functionality that is created as a means for our customers to make a transaction even if the processing center or communications links are temporarily down.

As in all cases of credit, there will be a risk of non-payment. But by keeping the credit limit adjusted as it is used on the card and by also reducing the limit when the card is made in an online transaction and the account balance is lower than the card credit the risk are kept in control as far as possible.

Merchant Card—Blob Storage and Retrieval

This is a function that allows the terminal to store opaque information blocks on the merchant card. It is planned to be used for two purposes.
To store the encrypted transactions being made when the terminal is off-line.
To store questionnaires and other information being sent to the merchant for later usage.

It is better to store this kind of information on the merchant smartcard instead of storing it in the file system of the terminal itself since the information will not get lost if the terminal is to be replaced.

Terminal Authenticity Verification

This new innovation solves problems raised when a terminal/device may have been tampered with.

This invention lets the user know that the device (e.g. EDC terminal, ATM, Info kiosk or a similar device) is authentic and have not been replaced with a fake device by a third party in order to collect personal data from the users.

By verifying that a picture (either a fixed image selected at the time of card personalization) or selected by the user himself is correctly shown on the device the user can be assured that the device has not been replaced by a facsimile. The picture will be shown before the user enters any information into the device.

Depending on the actual implementation the image can be kept in the card or in the device.

The images can either be real world pictures suitable to be displayed on devices with only low resolution monochrome displays, or a set of hand drawn geometrical images or an image generated algorithmically from the decrypted data.

It is also possible to store multiple images in various resolutions and/or color spaces in order to adapt to the capabilities of the current devices display.

Method 1:

1) The users smart card is inserted into the device

2) The device retrieves an image (encrypted with the public part of a public key infrastructure (PKI) key)

3) The device decrypts the image with the private part of a PKI key (shared by all devices)

4) The device shows the image on its display

Method 2:

1) The user's smart card is inserted into the device

2) The device retrieves an reference number (encrypted with the public part of a PKI key)

3) The device decrypts the number with the private part of a PKI key (shared by all devices). This number is an index into an array of stored images in the device.

4) The device shows the image on its display.

Electronic Bill Payment Systems and Methods Compatible with Non-Banking Consumers

One group of improvements uses the secure payment capabilities of the above architecture to implement a bill payment system. Electronic payments from consumers who are not bank customers are now completely secure. A variety of methods are discussed to include non-banking consumers in this payment system.

In today's world (traditional world) the vast majority of all solutions, services and also innovations are solutions or improvements to how and what we are used to do.

“We cannot solve our problems with the same thinking we used when we created them.” (Albert Einstein)

Electronic Bill Payments which in the year 2010 has truly reached beyond expectations (Europe) demonstrate how a normal costly process of handling the lifecycle of creating bills, distribute, collect payments and for the corporate users also make the ledger recording an integral part—without using any paper at all.

In most cases the number of involved parties (middleman) has increased, due to the fact that a processing center, convert the billing files to electronic bills and communicate those to the bank who facilitates the mechanism of disposing the record and collect the payments.

Or as an example set by other innovation US Patent US2010/0042537 A1 explains the way a system can be integrated as another link in the value chain and provide a service to both the Biller and the Payer and assist the user to gain benefits from paying in time.

“Traditional world” should be understood as how we have done and manage things up to now, 2010.

These existing solutions are constructed to serve bankable customer, customer who has a bank account and likely also access to internet, which is represented by the yellow top of the consumer pyramid in the picture to the right, which represents only 20% of the consumer in the world.

For both “Consumers” and “Corporations” they do share one crucial aspect, they must be a BANK customer, to be able to receive the electronic bill and make the payment, electronically, by using an interface and a device the bank has facilitated channel for, such us, Internet with online banking facilities, using mobile phone and access the service via a mobile solution and interact via a high-end device and using unstructured supplementary service data (USSD) or an application on the device, and as one example of communication network utilize global system for mobile communications (GSM).

Other channels to access such services could be via integrated voice response (IVR) solutions where the user dials in on a telephone number, identifying himself and then by different command techniques can instruct the system what to do, this can, as one example be by using the telephones dual-tone multi-frequency (DTMF) signals using the keyboard or just the number pad or by just simply using his or her own voice.

A system which handles the whole chain of events to pay a bill for non-bankable customer, typically emerging market, but not limited to, without the primary use of a printed bill, notification, request, remainder or written demand, which system also are suitable for Non-Bank institutions or by the way any other institution or organization who has a need to make the processing and or the handling settlement of values, via a better way.

A system which make it possible to be part of the modern e-society, without access to Internet or a bank account and still be able to interact and handle day to day transactions.

A system which handles; notification, verification, reminders, feed-backs, rescheduling response or action/s, payment and or settlement as well as channeling relevant data back-to or from a client and the service provider.

Saving the trees and forests around the world—making the solution in such manner that no paper is being used to communicate bills, notifications, statements or any other type of document which ‘normally’ is being send/given to a customer.

The disclosed inventions, in various embodiments, will handle the storage of any electronic material related a transaction, so that the user at any time, easily and effectively can preferable access the same online but if needed also have any record reproduced to other media, such as paper, electronic format, file or any other format available at such time.

The disclosed inventions, in various embodiments, can either operate as an integral solution to a typical billing and or administration system or operate as an offered service from a service provider or an entity offering solutions towards non-bankable customer, but not limited to.

The disclosed inventions, in various embodiments, can directly or via a service provider notify the customer by short message service (SMS) or any other type of notification system/service available for the customer, which can differ from location to location.

The disclosed inventions, in various embodiments, can handle, if needed both off-line as well as on-line transactions and it can also if suitable be implemented as an application in a customer device to handle part or whole of a transaction.

The disclosed inventions, in various embodiments, can have the feature to validate that a notification was both sent and displayed/visible for the customer, at a given time.

The disclosed inventions, in various embodiments, can also be integrated to a network or cluster of EDC/EFT or POS terminals, multi function and multi service terminals or electronic Business Machine (eBM) Terminals or any other device, such as information screens or information kiosks or any other device, which can display or print the notification or the details of the request, which also include any other future media of interact with the user.

The disclosed inventions, in various embodiments, can also be integrated or could use any such terminal in combination with the use of an identifier, stored value card, preferably equipped with a smart-chip or any other intelligent device, so that the user (costumer) can be identified and verified as the rightful user of such Identifier, where after the notification would be displayed or printed to the customer.

The disclosed inventions, in various embodiments, can also be integrated to such Terminals, so that when a customer can uses his or her card, stored value card, debit card, credit card or another type of card or identifier, the notification could appear as a message of a printed receipt.

The disclosed inventions, in various embodiments, can also be integrated with Terminal/s in such manner that the notification/request can suggest or demand a response or the customer may like to request or inform the Biller or the Client by entering the response directly on the Terminal in use.

The disclosed inventions, in various embodiments, can also in the case of use for bill payments and collection provide the service that when a customer is identified or entered a bill identification number, i.e. account or customer number, the bill, in this example, is due to be paid at a specific date, the customer may then enter an alternative payment date and or make a schedule for when the bill will be paid partly or whole. If applicable and offered as an online and instant service the billets system or the service provider or the processing center can than at such time directly respond back to accept such request or state the terms accepted or agreed.

The disclosed inventions, in various embodiments, can also be integrated and use OTP (one time pin) feature in any shape or form where also USSD or any application on a device such a mobile phone could communicate a second or third level of verification, to increase the level of security.

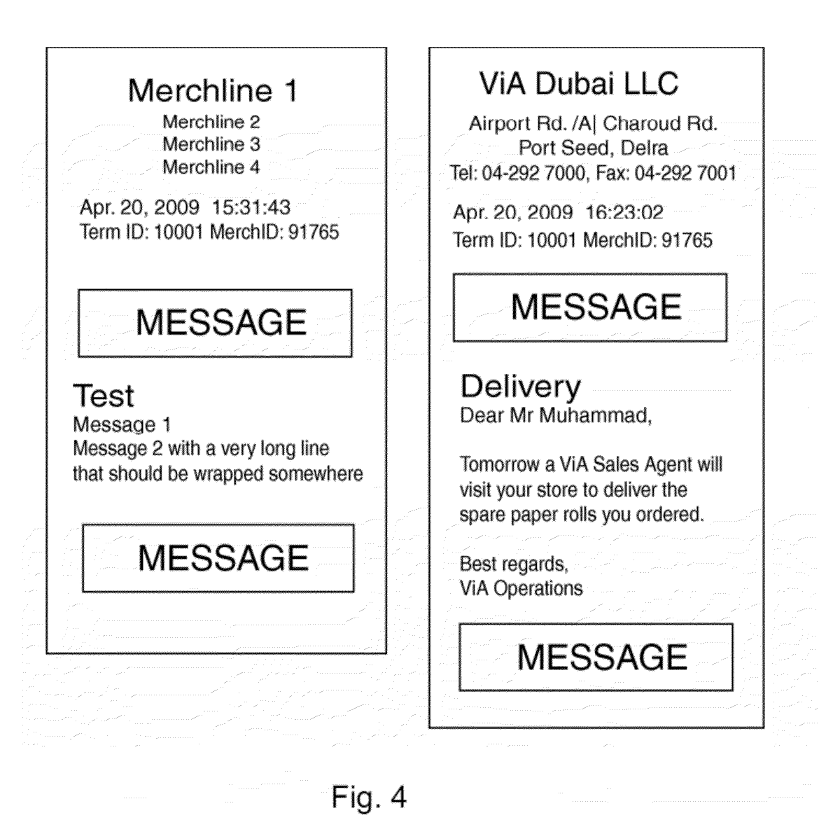

The disclosed inventions, in various embodiments, can also be integrated with Terminals, so when a customer is identified, by means of identifier, card, biometric data or any other method or techniques used at such time, the bill, request or form would be displayed or printed. As one example, if the Terminal has a printer, see FIG. 4, this is referred to as a simplified-printout, which can be combined with or in exchange of be made as a ‘full-print-out’ which is further explained in the tables below.

1 Collection of billing data This first step can as one example of explaining the process if it is to be used for handling the billing of electrical consumption, not limited to. Where the data can be reported

1.1 By service agent with online terminal visiting consumer

1.2 By service agent with offline terminal visiting consumer

1.3 By service agent with paper & pen visiting consumer, entering data at back office

1.4 By customer self reporting at service agent office

1.5 By customer self reporting at any SCT terminal

1.6 By customer self reporting via internet

1.7 By customer self reporting by cell phone/SMS/USSD

1.8 By online smart meter

1.9 By customer self reporting at a info kiosk

1.10 Or any other means or media, which also could include that the customer did bring some type of media from his location, which at a suitable service point could be read and data could be transferred in a more protected environment.

2 Notification of new bill “Notification of a new bill, is and can be used as a reminder, that therein is a bill or an event (payment, settlement, installment) which will occur in the near future, which for the prime target group is a feature they can not enjoy due to lack of basic tools such as electronic calendars, PCs, lap-tops and highend mobile phones or iPads etc. . . . depending on the Biller, this feature can use different medias to reach the consumer, via SMS, email, info-kiosks . . .

2.1 By SMS on cell phone

2.2 By message on any receipt printed on any SCT terminal

2.3 By direct message printed on any other printout from a system/terminal, which would have access to the same service, this can include, but is not limited to ATM machines and their printed reciepts or it can even be a normal cashier-machine print-out as long as that system is connected and utilizes the same service. These types of “message/s” or reminder/s can also appear on a screen, next to the cashier system or next to a POS terminal where information sharing and functions for display has been pre-arranged.

3 Bill retrieval

3.1 eMail as plain text or PDF

3.2 Fetch online as plain text or PDF

3.3 Printed by any SCT terminal, or any other terminal/printable device utilizing the service.

3.4 Viewed on cell phone as USSD service

3.5 Printed at an info kiosk

3.6 Viewed/Printed at service agent at time of payment, in a compact form, preferable printed on just a receipt paper, where core facts are printed

4 Due date adjustment “Notification of request outcome to be sent similar as in step 2 Note: If payment is made early customer may receive “payday-points” so he can pay a future bill late without incurring fees.”

4.1 Request to postpone due date on SCT terminal, or any other terminal/printable device utilizing the service.

4.2 Request to postpone due date at service agent

4.3 Request that payment will be made automatically at the due date or at a set date—pre-authorized payment

5 Payment collection

5.1 Payment by cash at any SCT terminal, or any other terminal/printable device utilizing the service.

5.2 Payment by SCT Card at any SCT terminal, or any other terminal/printable device utilizing the service.

5.3 Payment by using any mobile-device, using SMS or USSD or any other applicable user interface with instruction to deduct the payment from any type of account, in this case pre-paid so called stored value card account or it can also be deducted from a one-time cash card.

5.4 Payment by pre-authorized instructions as of point 4.3 above.

6 Overdue reminder 6.1 Any method as described in Step 2 above and in step 3.1, 3.2, 3.3, 3.4, 3.5

7 Termination of Service

The disclosed inventions, in various embodiments, can, depending on user groups be designed and deployed in such manner that when a customer (user) are using a card, or any other media to identify the user, the display or media can suggest, or printout can suggest that there is a bill to be paid or a number of bills to be paid or one or several forms or requests which should be dealt with. When we herein refer to display we refer to any media or medium which can signal, visualize the said content to the customer, which also include techniques for blind people and people with special needs.

This latest innovation is an answer to a global problem of using too much paper when handling subscriptions, utilities bills or any other channel of usage where paper is the way to communicate, notify and request, as in this example payment for a planned or delivered service.

This innovation also brings a whole new dimension to the table, when suddenly also the Emerging markets consumers (customer) Non-Bank's and Un-Bankable now utilize the full extent of electronic bill payment and settlement without having a bank account or Internet or a mobile-phone capable to facilitate similar solutions.

The following description of steps, outlining the principals of the claimed innovation to create a paper-free electronic billing and settlement system for Non-Bank and unbankable consumers or consumers, but is not limited to ‘just’ handle bill payments.

The system can be used for any other chain of events where a ‘normal’ paper structured way of channel facts, records, request is being exchanged to a paper-free or less solution as this claimed innovation.

Ultimate solution for everyone in a better way! PayRoll Cards, to handle salaries securely, for micro payments and remittances—an ultimate and simplified PayRoll Administrations solution online with a unique authorization management solution to increase efficiency for companies.

A time management and attendance solution, where even the worker can print out his payroll slip or his attendance record from any SCT POS terminal, in a shop, camp or office.

SCT Multi Function POS terminals will be provided to companies who will handle and distribute the PayRoll cards to the workers, free of charge during the agreed deployment phase.

ViA's initiative, the first in the world to offer an All In One™ solution for companies, workers and Governments, covering both the workers' needs and services abroad, remit salaries back home to supplementary and associated solutions, for the workers' loved ones. Affordable for everyone!

Payroll Service Architectures, Systems, and Methods allowing Electronic Transactions for Non-Banking Consumers

Another group of improvements uses the secure payment capabilities of the above architecture to implement a payroll system which allows non-banking or unbankable employees (or contractors or vendors) to receive electronic payment, and to easily reroute portions of their payments electronically to various destinations. The secure transaction capabilities of the above architecture make this possible.

The ViA PayRoll™ suite comprises of:

PayRoll Card: The SCT Card, preferably issued as a PayRoll Card (PIN enabled smartcard) ensures the workers have easy access to his salary without the need to withdraw cash from ATM's. Workers can use their SCT Cards for the smallest transactions and will find SCT POS terminals at many locations, including the labor camps.

This architecture also provides Online PayRoll administration for small and medium sized enterprises (and for larger companies). A simplified Batch & Upload solution is utilized where standard files can be administrated to handle thousands of workers' salaries.

PayRoll Authorization & Payment Support

A NEW innovative authorization feature for corporations to master their payroll services and an internal authorization matrix where payroll authorization and dispatch can NOW be handled by two or more authorization levels, with SMS alert notification.

Assume that a company would like to have a clerk prepare and enter all the online records and have a senior manager approve or sign off the salary records which have been entered online.

Today, this facility does not exist, but SCT has solved this issue by marking the instructions as pending until such time that the second person has verified the records and approves the salaries.

Workers & Government Window Workers can access their SCT Account information and manage their account details by using Internet or at Info Kiosks which are planned for the future, either via Mobile phones or by instructing a SCT Agent to assist the worker in adjusting or updating any information.

The Governments can easily monitor the SCT solution whereby they can see that salaries are being paid on time and can get any required reports within the rules and guidelines set by the Government.

Additionally the SCT administrator will also provide extensive statistics, previously unavailable to a Government.

SCT Multi Function POS Terminal

The SCT Multi Function POS terminal can now be found at labor camps and small merchants, where workers spend their time after work and where they can now use their SCT Cards rather than cash.

Additionally it is possible for them to print out pay slips, attendance reports, balance inquiries, receipts of remittances, or any another requested services from any SCT POS terminal.

Time Management and Attendance Solution & Services

The Time Management and Attendance solution has been developed for and targeted towards the small merchants with a small number of employees and who have one or more SCT POS terminals in their shop/office.

Each employee (clerk) has its own SCT Card that they would use to insert in the SCT POS terminal; they are then registered as being at the work.

If they then leave for any reason, that event can be properly recorded and can then be used when the salaries are prepared.

eMeal Solution for Labor Camp Canteens

The ViA eMeal solution is a modern way of eliminating food coupons and thereby saving money and making the whole process faster, more cost effective and also simplified for the workers.

Due to the frequency of use, we have suggested a separate meal card, as for example a simple barcode-based plastic card.

Elements which can be advantageously included in this system, in various embodiments, include various combinations and subcominations of the following:

The SCT Multi Function POS terminal

Salary solution via POS & Online

Attendance Time Management System

Time-slip printing and reports

Salary Slip

Micro statement—account

Status of Remittance

Card Activation

Changing the Pin

Updating and verifying SMS number

Payroll calculation Q4

Mobile Phone Top-Ups

Utility Bill Payment

Cash-IN with a maximum level/card/month

Cash-Out with a maximum level of AED 100/max 4 times a month.

Bill 2 Bill Payment Merchants

Card 2 Card transfer

Charity Donations

Donation Receipt & tracking

Remit 2 Home

Petty Cash deliver feature

According to some, but not necessarily all, disclosed embodiments, there is provided: A method for performing secure value transactions, comprising: allowing a human user to engage a first smartcard with a terminal; performing a preliminary tripwire step, wherein said first smart card and said terminal mutually contribute data fractions to mutually generate an image which is displayed to the human user on a display which communicates with at least some portions of said terminal; and, if the human user chooses to continue after viewing said image, then allowing said first card to initiate a secure data exchange, which is routed through said terminal, with a second smartcard; wherein said secure data exchange involves an exchange of value.

### MODIFICATIONS AND VARIATIONS

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

For example, STS data security techniques can be combined with the techniques in the present application. The Secure Transaction String concept (“STS”) is described in US2007-0033149, which is hereby incorporated by reference. This security architecture mitigates the problem of sharing too much information between the parties involved in POS transaction in the current networks. There are several gateways, processing & fraud detection centers involved while the transaction is en route to the issuing bank for the authorization. By dividing the data to be sent into several blocks, each encrypted with a separate key, one can reduce the amount of information sharing and possible attack points in the chain. For instance the first link in the chain only needs to know enough of the card number to deduce where to route the rest of the information, the rest of the information will still be encrypted by other keys that the first link doesn't have access to. If this link is compromised, or against the rules stores all transactions locally unencrypted, the other blocks are still encrypted and secure.

Another possibility is that a card can be a contactless device using any wireless interface such as radio frequency identification (RFID) or near-field communication (NFC).

Another possibility is that the “card” does not necessarily have the familiar form factor of a credit card or smart card. Instead, it can be configured as a “data key” or fob or ring or otherwise.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A method for performing secure value transactions, comprising:
allowing a human user to engage a first smartcard with a terminal;
performing a preliminary tripwire step, wherein said first smart card and said terminal mutually contribute data fractions to mutually generate an image which is displayed to the human user on a display which communicates with at least some portions of said terminal;
and, if the human user chooses to continue after viewing said image, then allowing said first card to initiate a secure data exchange, which is routed through said terminal, with a second smartcard;
wherein said secure data exchange involves an exchange of value.

2. The method of claim 1, wherein said exchange involves a payment of funds referenced to a specific bank network.
